(19) United States
(12) Patent Application Publication
(10) Pub. No.: US 2007/0165231 A1
(43) Pub. Date: Jul. 19, 2007

(54) Gas Sensor And Method For The Production Thereof

(76) Inventors: Robert Frodl, Munchen (DE); Rudi Minuth, Freising (DE); Reinhold Maehlich, Munchen (DE); Joerg Fischer, Munchen (DE); Simone Fehlberg, Munchen (DE); Rainer Nothelfer, Germering (DE); Kuno Straub, Freising (DE)

Correspondence Address: BARLEY SNYDER, LLC, 1000 WESTLAKES DRIVE, SUITE 275, BERWYN, PA, 19312, US

(21) Appl. No.: 11/624,504

(22) Filed: Jan. 18, 2007

(30) Foreign Application Priority Data
Jan. 19, 2006 (DE) 102006002870.8

(51) Int. Cl. G01N 21/00; G01J 5/02

(52) U.S. Cl. 356/437; 250/343

(57) ABSTRACT

A gas sensor having a base, a light source having a lamp body, the light source being carried by the base, a first reflector associated with the light source, a detector for detecting the intensity of the light source, and a lampholder for play-free and immobile securing of the lamp body is disclosed.

### CROSS-REFERENCE TO RELATED APPLICATIONS

This application claims the benefit of the filing date under 35 U.S.C. § 119(a)-(d) of foreign patent application DE 10 2006 002 870.8 filed Jan. 19, 2006.

### FIELD OF THE INVENTION

The present invention relates to a gas sensor and more particularly to a gas sensor having a radiation source and a detector.

### BACKGROUND

Many gas sensors make use of the selective absorption of infrared radiation by gases. Gas sensors based on infrared absorption known from the prior art comprise a radiation source, a measuring chamber and a detector. Inside the measuring chamber, certain radiation wavelengths are absorbed by a gas to be detected. The gas selectivity of a gas sensor may be produced, for example, by a radiation source which emits light only in a wavelength range which is absorbed by the gas to be detected. Alternatively, an interference filter may be arranged in the measuring chamber, for example, which transmits in the wavelength range which is absorbed by the gas to be detected. The absorption results in a reduction in the radiation intensity which is detected by the detector. This change in intensity may be described by the so-called Lambert-Beer law. The intensity detected by the detector is thus a measure of the concentration of the gas.

A gas sensor of the above type is disclosed in DE 103 19 186 A1. That gas sensor for a vehicle air conditioning system has an infrared radiation source, which comprises an incandescent bulb and a reflector, wherein the incandescent bulb is arranged at the focal point of the reflector. In order to achieve high measuring accuracy, the prior art generally proposes to separate both the radiation source and the detector from the measuring chamber in each case by a film which allows only a wavelength range of relevance to measurement to pass therethrough. In this way, it is also intended to prevent soiling of the optical components. However, the arrangement of these films results in a complex structure for the gas sensor housing. Thus, the provision of such a gas sensor is not only very complicated but also expensive. In addition, it has become apparent in practice that satisfactory measuring accuracy cannot be ensured despite this complex and time-consuming generic gas sensor structure. This is particular true in the case where the gas sensor is exposed to vibration loads during operation of the motor vehicle.

### SUMMARY

It is thus an object of the present invention to provide a low-cost gas sensor which exhibits high measuring accuracy and a simple structure. In addition, it is an object of the present invention to provide a method for the low-cost production of such a gas sensor.

These and other objects are achieved by a gas sensor according to the invention having a base, a light source having a lamp body, the light source being carried by the base, a first reflector associated with the light source, a detector for detecting the intensity of the light source, and a lampholder for play-free and immobile securing of the lamp body.

### BRIEF DESCRIPTION OF THE DRAWINGS

Further details, advantages and features of the present invention will become apparent from the following description of an exemplary embodiment together with the drawings, in which:

FIG. 1 is a schematic view of a gas sensor according to an embodiment of the present invention;

FIG. 2 is a sectional view of the gas sensor of FIG. 1 showing a light source installed into a base;

FIG. 3a is a schematic view of a step according to a method of producing the gas sensor of FIG. 1; and

FIG. 3b is a schematic view of a step of the method of FIG. 3a, the step being subsequent to the step of FIG. 3a.

### DETAILED DESCRIPTION OF THE EMBODIMENT(S)

For the purposes of the invention, the lamp body 10 of the light source 4 is that component which separates the radiation-emitting element of the light source 4 from the surrounding environment. In the case of an incandescent bulb, the lamp body 10 is thus the glass envelope which separates a wire filament, which constitutes the radiation-emitting element, from the surrounding environment. In the case of a light-emitting diode, the lamp body 10 according to the invention corresponds to the transparent plastic sheath of the light-emitting diode. It is assumed that the radiation-emitting element, i.e. the wire filament for example, is connected firmly to the lamp body 10.

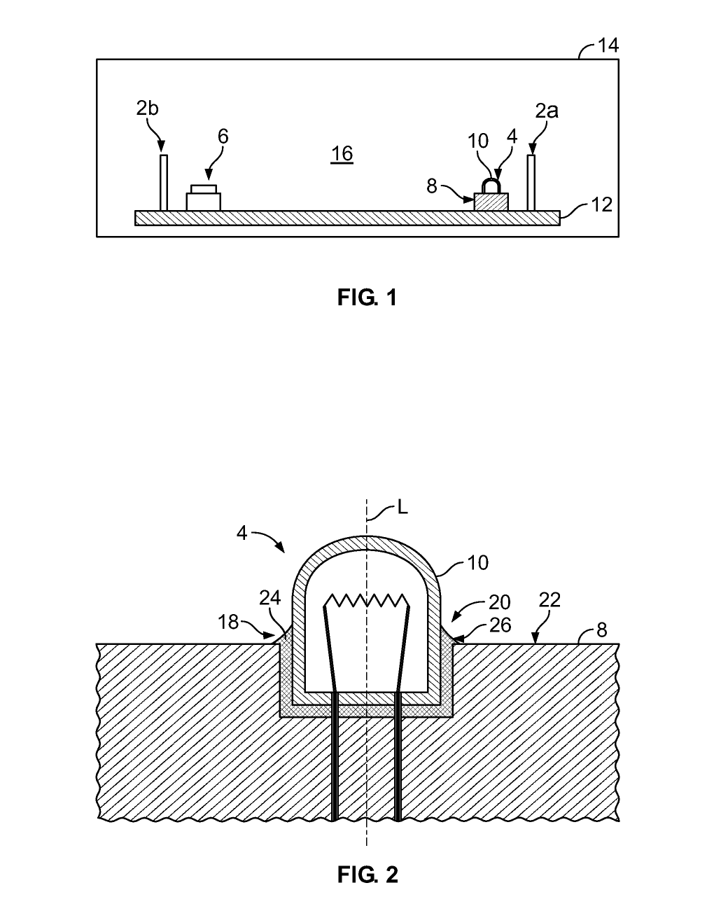

FIG. 1 shows a first reflector 2a and a second reflector 2b, which are associated, respectively, with an infrared light source 4 and an infrared detector 6. Both the light source 4 and the detector 6 are arranged at the focal point of the associated reflectors 2a, 2b. The light source 4 installed into a base 8 comprises a lamp body 10. The reflectors 2a, 2b, the base 8 and the detector 6 are mounted on a printed circuit board 12, which is arranged in a gas sensor housing 14. The gas to be detected is introduced into this housing 14 optionally by forced flow. It should be pointed out that the arrangement of the detector 6 and the light source 4 is not restricted to the structure shown. Instead, the detector 6 and the light source 4 may also be arranged in parallel next to one another.

FIG. 2 shows a sectional view of the base 8 and the light source 4. Part of a lampholder 20 for securing the lamp body 10 in a play-free and immobile manner is formed between the inside of a base receptacle 18 and a portion of the lamp body 10 received in the base receptacle 18. The lampholder 20 projects beyond the open end of the base receptacle 18 and lies against the lamp body 10 over a portion of the circumferential surface thereof. The part of the lampholder 20 which projects beyond the open end is formed as an inclined portion 24 between a surface 22 of the base 8 and the circumferential surface portion of the lamp body 10. The lampholder 20 lies imperviously against both the lamp body 10 and the inside of the base receptacle 18. The inclined portion 24 forms a type of widened support for the lamp body 10, which improves stability. Further, the inclined portion 24 formed between the surface 22 of the base 8 and the circumferential surface of the lamp body 10 displays an obliquely extending exterior 26. In this way, a supporting portion is formed which, together with the part of the lampholder 20 formed in the base receptacle 18, effectively prevents deflection of the lamp body 10 transversely and lengthwise of the longitudinal axis L thereof under vibration loading.

The precise arrangement of the lamp body 10 in relation to an associated first reflector 2a has an effect on achieving high measuring accuracy. To this end, it is desirable to position the lamp body 10 at the focal point of the associated first reflector 2a. A lampholder 20 for play-free and immobile securing of the lamp body 10 ensures that the lamp body 10 is not moved out of the focal point position under vibration loads. In particular it is ensured that the lamp body 10 is arranged in play-free and immobile manner relative to the base 8. Thus, the lamp body 10 does not move relative to the base 8. For the purposes of the invention, play-free and immobile means that the lamp body 10 cannot be deflected transversely or lengthwise of its longitudinal axis, which extends through the focal point. Practical experiments have demonstrated that even very slight deflection of the lamp body 10 has a considerable effect on the measuring accuracy of a gas sensor. The gas sensor according to the invention makes high measuring accuracy possible even under vibration loads. The lampholder 20 may be constructed, for example, from a plurality of elements spaced from one another in the circumferential direction of the lamp body 10, said elements lying against the circumferential surface of the lamp body 10. Thus, the lampholder 20 may consist of a plurality of elements and is not restricted to a component of one-piece construction. The lampholder 20 may optionally only lie against a lower portion of the circumferential surface of the lamp body 10. The lower portion is that portion which is adjacent the base 8.

For the purposes of the invention, the base 8 may take the form, for example, of a component designed for mounting on a printed circuit board. However, the base 8 may also be formed by the printed circuit board per se, for example as a receptacle integrated into the printed circuit board or as a hole formed in the printed circuit board, into which the light source 4 is installed.

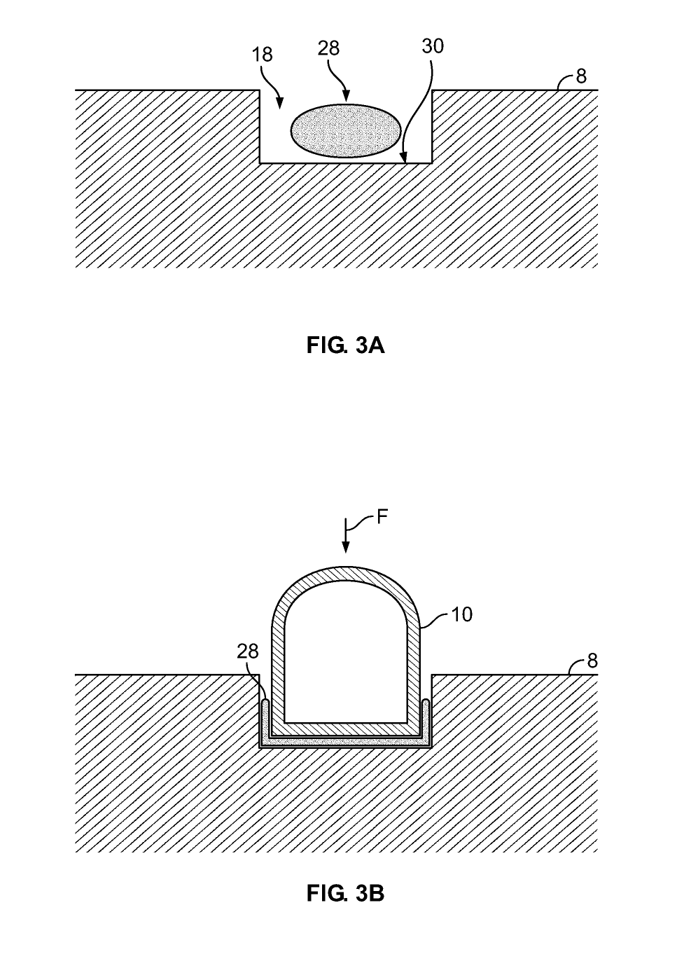

FIG. 3a and FIG. 3b show steps involved in an exemplary embodiment of a method for mounting the light source 4 in the base 8 and thereby producing the gas sensor shown in FIG. 1 and FIG. 2.

FIG. 3a shows the base 8, which is, in particular, a so-called Surface Mounted Device (SMD) base. A fluid 28, in this case a liquid adhesive, for joining the lamp body 10 to the base 8 has been introduced into the base receptacle 18 of the base 8 by a feed unit which is not shown. The fluid 28 is introduced in such a way that it covers only a part of a bottom face 30 of the base receptacle 18. The quantity of fluid 28 is adjusted so that the fluid 28 extends, when solidified, even as far as beyond the open end of the base receptacle 18 to form the lampholder 20.

FIG. 3b shows the step of installing the light source 4. It should be pointed out that only the lamp body 10 of the light source 4 has been illustrated so as to simplify the illustration. The lamp body 10 is installed into the base receptacle 18 under constant force in the direction of arrow F. Upon installation, the bottom of the lamp body 10 comes into contact with the fluid 28, which is displaced outwards thereby, i.e. towards the side wall of the base receptacle 18. When it reaches the side wall, the direction of flow of the fluid 28 is diverted so as to flow into an annular gap formed between the lamp body 10 and the side wall, against gravity. The lamp body 10 is moved in the direction of arrow F, until the fluid 28 is displaced beyond the open end of the base receptacle 18. Once the process of installing the lamp body 10 is complete, the fluid 28 solidifies to form the lampholder 20. This process may, if desired, be accelerated by measures known to the person skilled in the art, e.g. heating an adhesive to achieve more rapid curing.

With the above-described method, a lampholder 20 like the one shown in FIG. 2 is produced. Since the fluid 28 is displaced between the inner surface of the base receptacle 18 and the lamp body 10 while in liquid form, the resulting lampholder 20 fits precisely and imperviously against the contour of the base receptacle 18 and lamp body 10. In particular, the entire space between the lamp body 10 and the base receptacle 18 is filled with the fluid 28. This effective lampholder 20 secures the lamp body 10 at the focal point position and thus prevents relative movement between the lamp body 10 and the base 8. In particular, the construction of the inclined portion 24 ensures very good mechanical stability. Thus, a gas sensor which is insensitive to shocks and/or vibration loading is provided by the method described above.

According to another embodiment of the present invention, a lampholder 20 for play-free and immobile securing of a lamp body 10 of a light source 4 is also formed by solidification of a fluid 28, in this case an adhesion promoter, which is displaced relative to the lamp body 10 while largely in the liquid state. The adhesion promoter is displaced on insertion of the light source 4 into the base 8. In this way, a lampholder 20 is produced which matches the contour of the circumferential surface of the lamp body 10 against which it lies. The adhesion promoter thus not only achieves improved fastening of the lamp body 10 to the base 8, for example, but also increased mechanical stability of the entire gas sensor. The adhesion promoter additionally exhibits the advantage that no drilling, screwing or similar method is needed to fasten the lampholder 20 to the base 8, for example. Thus, the material properties of the base 8 are not negatively affected. In addition, the lampholder 20 produced using the adhesion promoter lies in sealing manner between the base 8 and the lamp body 10 and thus prevents dirt particles from penetrating between these components. The adhesion promoter may also sheath electrical conductors to the light source 4 and thus insulate them relative to the base 8.

According to another embodiment of the present invention, when solidified, the lampholder 20 surrounds at least part of the circumference of the lamp body 10. The lampholder 20 surrounds the lamp body 10 over the entire circumferential surface of the lower portion of the lamp body 10 and extends over the bottom of the lamp body 10. The bottom of the lamp body 10 should be understood to mean the outer side of the lamp body 10 which is arranged facing the surface of the base 8. The part of the lampholder 20 which lies against the circumferential surface of the lamp body 10 comprises an upper portion which is of a thicker or wider construction than the lower portion thereof. In this way, increased stability is achieved under vibration loads.

According to another embodiment of the present invention, the lampholder 10 is formed between the inside of a base receptacle 18 and the outside of a lamp body portion received in the base receptacle 18. The base receptacle 18 may be a hole provided in the base 8, the depth of which is, for example, no greater than the height of the lower lamp body portion, such that the radiation-emitting element is always positioned outside the base receptacle 18. Since the lampholder 20 is constructed between the outside of said lamp body portion and the inside of the base receptacle 18, the lamp body 10 is secured in a play-free and immobile manner relative to the base 8. The interplay between the base receptacle 18 and the lampholder 20 provides particularly high mechanical stability under vibration loading.

According to another embodiment of the present invention, a lampholder 20 portion projecting beyond the open end of the base receptacle 18 is of inclined construction. The inclined portion 24 lies against the outer circumferential surface of the lamp body 10 and against the surface of the base 8. The exterior 26 of the inclined portion 24 falls away obliquely from the outer circumferential surface of the lamp body 10 towards the surface of the base 8. In this way, a particularly effective support is formed for securing the lamp body 10.

According to another embodiment, the lamp body 10 and the base 8 are bonded together, by a fluid 28, in this case an adhesion promoter, applied in molten form and set. In this way, an effective bond is achieved without a negative effect on the material properties of the base 8 and/or of the lamp body 10. The adhesion promoter may for example be heat-setting.

According to another embodiment, any fluid 28 such as an adhesive is used. If an adhesive is used, the lampholder 20 for play-free and immobile securing of the lamp body 10 may be produced cheaply. A further advantage of the adhesive is that it may be used effectively for virtually all groups of material. It is advantageous to use an adhesive which displays high surface adhesion.

According to another embodiment, the lampholder 20 and the base 8 are of identical material. According to this embodiment, play-free and immobile securing is brought about by the base 8 portion formed in the immediate vicinity of the lamp body 10. Thus, for example, the material of the base 8 may be locally melted to a fluid-like state and thus the existing material may be used.

Another embodiment of the present invention includes a second reflector 2b associated with the detector 6 and a detector holder for play-free and immobile securing of the detector 6. Play-free and immobile securing of the detector 6 at the focal point position of the second reflector 2b associated therewith makes it possible to further improve the measuring accuracy of the gas sensor. The detector holder for play-free and immobile securing of the detector 6 may take the same form as the lampholder 20 for play-free and immobile securing of the lamp body 10.

According to another embodiment of the present invention, a method is provided for producing a gas sensor, which is characterized by introduction of the light source 4 with interposition of fluid 28 such as a liquid agent between the light source 4 and the base 8 and solidification of the liquid agent to form a lampholder 20 which is ultimately solid, whereby a lamp body 10 of the light source 4 is secured in a play-free and immobile manner in the solid lampholder 20.

According to another embodiment, the liquid agent is applied to the base 8. The liquid agent is applied, for example, to a portion of the surface of the base 8, the size of which corresponds to the surface area of the bottom of the lamp body 10. Alternatively, the liquid agent may be applied to a surface portion which is smaller in size than the surface area of the bottom of the lamp body 10. Upon installation of the light source 4, the agent is in this case displaced in such a way that it lies in an intermediate position at least against the entire surface of the bottom of the lamp body 10 and the opposing surface of the base 8. When installing the light source 4, the agent is provided at least between a bottom of the lamp body 10 and a surface of the base 8 opposite the bottom. The light source 4 is thus introduced in such a way that at least the bottom of the lamp body 10 is brought into contact with the liquid agent. Thus, on installation, the agent is adapted simultaneously to the lamp body 10 and the base surface 22, such that on completion of installation, the agent comprises a form which matches the contour of the lamp body 10 and base surface 22. As a result of subsequent solidification, a lampholder 20 for play-free and immobile securing of the lamp body 10 is simply produced. Since installation of the lamp body 10 simultaneously forms the lampholder 20, gas sensors may be simply and quickly produced by the method. A separate method for producing the lampholder 20 is thus not necessary according to the invention.

According to another embodiment, the lampholder 20 is formed by introducing the light source 4 into a material of the base 8 which flows when heated. The base 8 is heated, for example, by a heating unit in such a way that the heated base portion becomes liquid, wherein the light source 4 is then introduced. According to a further embodiment, the material of the base 8 is locally heated, i.e. only the base portion serving to receive the light source 4 is heated.

What is claimed is:

1. A gas sensor, comprising:
a base;
a light source having a lamp body, the light source being carried by the base;
a first reflector associated with the light source;
a detector for detecting the intensity of the light source; and
a lampholder for play-free and immobile securing of the lamp body.

2. The gas sensor according to claim 1, wherein the lampholder is formed by solidification of an adhesion promoter displaced relative to the lamp body while in a substantially liquid state.

3. The gas sensor according to claim 2, wherein the lampholder surrounds at least part of the circumference of the lamp body.

4. The gas sensor according to claim 3, wherein the circumferential surface of the lampholder takes the form of an incline in contact with the base.

5. The gas sensor according to claim 3, wherein the lampholder is formed between the inside of a base receptacle and the outside of a lamp body portion received in the base receptacle.

6. The gas sensor according to claim 5, wherein an inclined portion projects beyond an open end of the base receptacle.

7. The gas sensor according to claim 1, wherein the lamp body and the base are bonded together.

8. The gas sensor according to claim 1, wherein the lampholder is formed of an adhesive.

9. The gas sensor according to claim 1, wherein the lampholder and the base are of identical material.

10. The gas sensor according to claim 1, further comprising:
a second reflector associated with the detector; and
a detector holder for play-free and immobile securing of the detector.

11. A method for producing a gas sensor, comprising the steps of:
interposing a fluid between a lamp body of a light source and a base; and
solidifying the fluid thereby securing the lamp body in a play-free and immobile manner in the solidified fluid.

12. The method according to claim 11, wherein the fluid is applied to the base.

13. The method according to claim 11, wherein some of the fluid is displaced and solidifies to form a lampholder surrounding at least part of a circumference of the lamp body.

14. The method according to claim 11, wherein the fluid is introduced into a base receptacle for receiving the light source and some of the fluid is displaced into a gap between the base receptacle and the lamp body.

15. The method according to claim 14, wherein the fluid is displaced beyond an edge of the open end of the base receptacle onto a surface of the base.

16. The method according to claim 15, wherein the fluid displaced beyond the edge is inclined.

17. The method according to claim 11, wherein the lamp body and the base are bonded together.

18. The method according to claim 13, wherein the fluid is a material of the base which flows when heated and wherein the lampholder is formed by installing the light source into the material of the base while the material of the base is heated.

19. The method according to claim 18, wherein the material of the base is heated locally.

20. The method according to claim 11, wherein the fluid is an adhesive.
